(19) United States
(12) Patent Application Publication
(10) Pub. No.: US 2026/0099962 A1
(43) Pub. Date: Apr. 9, 2026

(54) METHOD, APPARATUS AND DEVICE FOR CONTROLLING SCENE RENDERING, AND STORAGE MEDIUM

(71) Applicant: GOERTEK INC., Weifang (CN)

(72) Inventors: Xiangjun ZHANG, Weifang (CN); Guoshu HUANG, Weifang (CN); Bin JIANG, Weifang (CN)

(21) Appl. No.: 19/417,160

(22) Filed: Dec. 11, 2025

Related U.S. Application Data
(63) Continuation of application No. PCT/CN2024/136724, filed on Dec. 4, 2024.

(30) Foreign Application Priority Data
May 14, 2024 (CN) 202410598381.1

(51) Int. Cl. G06T 11/10; G06T 7/246; G06T 7/73

(52) U.S. Cl. CPC G06T 11/10; G06T 7/246; G06T 7/73; G06T 2207/10016; G06T 2207/10024

(57) ABSTRACT

A method, an apparatus and a device for controlling scene rendering, and a storage medium are provided. The method for controlling scene rendering includes: determining a video perspective descriptor based on an image for a first thread, and determining a tracking and positioning descriptor based on an image for a second thread; matching the video perspective descriptor with the tracking and positioning descriptor; rendering a current virtual space based on a descriptor matching result to obtain a target virtual space; and obtaining a current pose for a target smart device, and determining a real scene image based on the current pose and the target virtual space.

### CROSS-REFERENCE TO RELATED APPLICATIONS

This application is a continuation application of International Application No. PCT/CN2024/136724, filed on Dec. 4, 2024, which claims priority to Chinese Patent application No. 202410598381.1, filed on May 14, 2024. The disclosures of the above-mentioned applications are incorporated herein by reference in their entireties.

### TECHNICAL FIELD

The present application relates to the technical field of smart devices, and in particular to a method, an apparatus and a device for controlling scene rendering, and a storage medium.

### BACKGROUND

Video-see through (VST) technology is widely used in smart devices, such as an augmented reality (AR) device and a virtual reality (VR) device. Currently, a common scene rendering method involves using a red, green, blue (RGB) camera with VST to perceive the surrounding environment and then using the RGB camera to mimic the human eye in determining the real scene image. However, in order to achieve clearer vision without sacrificing the field of view, the resolution of the RGB camera must be significantly higher; otherwise, high color rendering is difficult to achieve. However, commonly used RGB cameras are not very large, therefore, the above method cannot achieve high color rendering at low resolution.

The above content is only for assisting in understanding the technical solution of the present application and does not imply acceptance that the above content is related art.

### SUMMARY

The main purpose of the present application is to provide a method, an apparatus and a device for controlling scene rendering, and a storage medium, aiming to solve the technical problem that existing technologies cannot achieve high color rendering at low resolution.

In order to achieve the above purpose, the present application provides a method for controlling scene rendering, and the method for controlling scene rendering includes:
determining a video perspective descriptor based on an image for a first thread, and determining a tracking and positioning descriptor based on an image for a second thread;
matching the video perspective descriptor with the tracking and positioning descriptor;
rendering a current virtual space based on a descriptor matching result to obtain a target virtual space; and
obtaining a current pose for a target smart device, and determining a real scene image based on the current pose and the target virtual space.

In an embodiment, the determining the video perspective descriptor based on the image for the first thread includes:
after triggering video perspective function, acquiring the image for the first thread through a first camera device;
converting the image for the first thread to obtain a current black and white single-channel image;
performing pyramid layering on the current black and white single-channel image;
performing feature detection on the current black and white single-channel image after performing pyramid layering to obtain a first feature point; and
obtaining a first grayscale difference data based on the first feature point, and determining the video perspective descriptor based on the first grayscale difference data.

In an embodiment, the determining the tracking and positioning descriptor based on the image for the second thread includes:
after triggering the tracking and positioning function to start, acquiring the image for the second thread through a target measurement unit and a second camera device;
selecting a reference black and white single-channel image from the image for the second thread;
performing pyramid layering on the reference black and white single-channel image;
performing feature detection on the reference black and white single-channel image after performing pyramid layering to obtain a second feature point; and
obtaining a second grayscale difference data based on the second feature point, and determining the tracking and positioning descriptor based on the second grayscale difference data.

In an embodiment, the rendering the current virtual space based on the descriptor matching result to obtain the target virtual space includes:
obtaining a successfully matched descriptor based on the descriptor matching result;
looking up a current channel image in the image for the first thread based on the successfully matched descriptor;
assigning a preset attribute to the current channel image; and
determining the target virtual space based on the current channel image assigned with preset attribute.

In an embodiment, the determining the target virtual space based on the current channel image assigned with preset attribute includes:
constructing a current virtual space based on the current channel image assigned with preset attribute;
projecting a feature point corresponding to the successfully matched descriptor onto the current virtual space;
obtaining a target feature point adjacent to the feature point; and
interpolating the current virtual space after projecting based on a color for the target feature point to obtain the target virtual space.

In an embodiment, the obtaining the current pose for the target smart device and determining the real scene image based on the current pose and the target virtual space includes: obtaining the current pose for the target smart device;
obtaining the real scene image in the target virtual space based on the current pose; and
correspondingly, after determining the real scene image based on the current pose and the target virtual space, the method further includes:
sending the real scene image to the target display device so that the target display device displays the real scene image.

In an embodiment, the obtaining the current pose for the target smart device includes:
after triggering the tracking and positioning function to start, controlling the target smart device to perform simultaneous localization and mapping (SLAM) processing;
acquiring an image and motion data in a current scene during a tracking phase; and
determining the current pose for the target smart device based on the image and motion data in the current scene.

In addition, the present application also provides an apparatus for controlling scene rendering, and the apparatus for controlling scene rendering includes:
a descriptor determination module configured to determine a video perspective descriptor based on an image for a first thread and determine a tracking and positioning descriptor based on an image for a second thread;
a matching module configured to match the video perspective descriptor with the tracking and positioning descriptor;
a rendering module configured to render a current virtual space based on a descriptor matching result to obtain a target virtual space; and
a scene image determination module configured to acquire a current pose for a target smart device, and determine a real scene image based on the current pose and the target virtual space.

In addition, the present application also provides a device for controlling scene rendering, including: a memory, a processor, and a computer program stored in the memory and executable on the processor, and the computer program is configured to implement the method for controlling scene rendering described above.

In addition, the present application also provides a non-transitory storage medium, the storage medium is a non-transitory computer-readable storage medium, a computer program is stored on the storage medium, and when the computer program is executed by a processor, the method for controlling scene rendering described above.

One or more technical solutions proposed in the present application have at least the following technical effects. Determining a video perspective descriptor based on an image for a first thread, and determining a tracking and positioning descriptor based on an image for a second thread; matching the video perspective descriptor with the tracking and positioning descriptor; rendering a current virtual space based on a descriptor matching result to obtain a target virtual space; and obtaining a current pose for a target smart device, and determining a real scene image based on the current pose and the target virtual space. By acquiring images from different threads in the above manner, determining corresponding descriptors using their respective images, rendering the target virtual space using the descriptor matching result, and finally combining the current pose for the target smart device to determine the real scene image, thereby achieving high color rendering at low resolution and breaking through the resolution limitations of camera devices.

### BRIEF DESCRIPTION OF THE DRAWINGS

The drawings incorporated in the specification form a part of the specification and shows embodiments corresponding to the present application, and are used to explain the principle of the present application together with the specification

In order to illustrate the technical solutions in the embodiments of the present application or in the related art more clearly, the following briefly introduces the accompanying drawings required for the description of the embodiments or the related art. Obviously, for those skilled in the art, other drawings can also be obtained according to the structures shown in these drawings without any creative effort.

FIG. 1 is a flow chart of a method for controlling scene rendering according to an embodiment of the present application.

FIG. 2 is a flow chart of the method for controlling scene rendering according to another embodiment of the present application.

FIG. 3 is a simplified flow chart of the method for controlling scene rendering according to another embodiment of the present application.

FIG. 4 is a schematic diagram of a module structure of an apparatus for controlling scene rendering according to an embodiment of the present application.

FIG. 5 is a schematic diagram of a device structure of the hardware operating environment involved in the method for controlling scene rendering according to an embodiment of the present application.

The achievement of the objectives, functional features, and advantages of the present application will be further explained with reference to the embodiments and accompanying drawings.

### DETAILED DESCRIPTION OF THE EMBODIMENTS

It should be noted that the execution subject in this embodiment can be a computing service device with data processing, network communication, and program execution functions, such as a tablet computer, a personal computer, or a mobile phone, or an electronic device or a smart device controller capable of performing the above functions. The following description uses a smart device controller as an example to illustrate this embodiment and the subsequent embodiments.

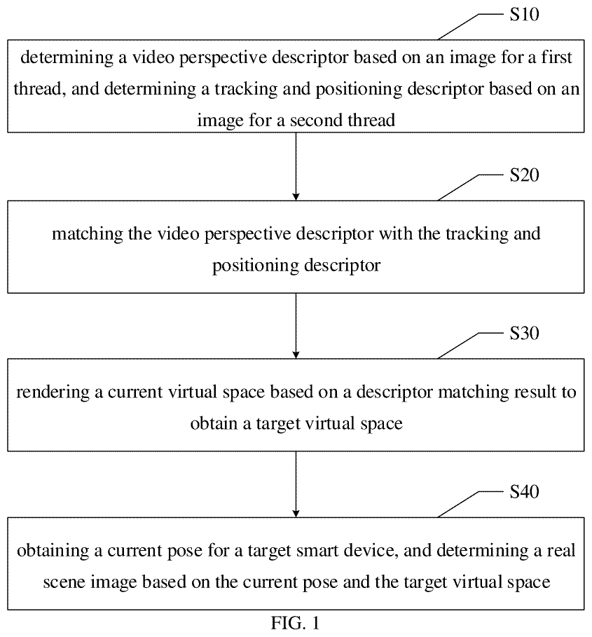

Based on this, the present application provides a method for controlling scene rendering. Referring to FIG. 1, FIG. 1 is a flow chart of a method for controlling scene rendering according to an embodiment of the present application.

In this embodiment, the method for controlling scene rendering includes step S10 to step S40.

Step S10, determining a video perspective descriptor based on an image for a first thread, and determining a tracking and positioning descriptor based on an image for a second thread.

It should be noted that the first thread can be a video perspective thread, and the second thread can be a tracking and positioning thread. The image for the first thread can be captured by the first camera device, and the first camera device can be an RGB camera. The image for the second thread can be acquired by the target measurement unit and the second camera device. The target detection unit can be an inertial measurement unit (IMU), and the second camera device can be a 6 degree of freedom (DOF) camera.

In an embodiment, the determining the video perspective descriptor based on the image for the first thread includes: after triggering video perspective function, acquiring the image for the first thread through a first camera device; converting the image for the first thread to obtain a current black and white single-channel image; performing pyramid layering on the current black and white single-channel image; performing feature detection on the current black and white single-channel image after performing pyramid layering to obtain a first feature point; and obtaining a first grayscale difference data based on the first feature point, and determining the video perspective descriptor based on the first grayscale difference data.

It should be understood that the video perspective function can be activated by the user using the first trigger command issued by the start button. After acquiring the first thread image through the first camera device, backing up the first thread image. Then, converting the first thread image after backing up into the current black and white single-channel image, and performing pyramid layering on the current black and white single-channel image, that is, expressing the current black and white single-channel image in a plurality of dimensions. The first feature point refers to the feature point in the current black and white single-channel image after performing pyramid layering, and the strategy used in feature detection can be the oriented FAST and rotated BRIEF (ORB) detection strategy. The first grayscale difference data refers to the grayscale difference data of the pixel pairs surrounding the first feature point. Then, using the first grayscale difference data to generate the first binary string, and taking the first binary string as the video perspective descriptor.

In an embodiment, the determining the tracking and positioning descriptor based on the image for the second thread includes: after triggering the tracking and positioning function to start, acquiring the image for the second thread through a target measurement unit and a second camera device; selecting a reference black and white single-channel image from the image for the second thread; performing pyramid layering on the reference black and white single-channel image; performing feature detection on the reference black and white single-channel image after performing pyramid layering to obtain a second feature point; and obtaining a second grayscale difference data based on the second feature point, and determining the tracking and positioning descriptor based on the second grayscale difference data.

It can be understood that the tracking and positioning function can be activated by the user using a second trigger command issued by the start button. The reference black and white single-channel image refers to the image captured by the reference camera for the simultaneous localization and mapping (SLAM) visual odometry. The reference camera can be the left camera by default, or it can be other custom cameras. After acquiring the second thread image through the target measurement unit and the second camera device, selecting the reference black and white single-channel image from the second thread image. Then, performing pyramid layering and feature detection in the same way. The strategy used in feature detection can also be the ORB detection strategy. The second grayscale difference data refers to the grayscale difference data of the pixel pairs surrounding the second feature point. Then, using the second grayscale difference data to generate the second binary string, and taking the second binary string as the tracking and positioning descriptor.

Step S20, matching the video perspective descriptor with the tracking and positioning descriptor.

It can be understood that after obtaining the video perspective descriptor and the tracking and positioning descriptor, matching the video perspective descriptor with the tracking and positioning descriptor to obtain the descriptor matching result.

Step S30, rendering a current virtual space based on a descriptor matching result to obtain a target virtual space.

It can be understood that the descriptor matching result includes successfully matched descriptor points and unmatched descriptor points. The current virtual space can be constructed using the coordinates of feature points, and the target virtual space can be obtained by rendering the current virtual space using color.

Step S40, obtaining a current pose for a target smart device, and determining a real scene image based on the current pose and the target virtual space.

It should be understood that the current pose refers to the pose for the target smart device at the current moment. The target smart device can be a device used in a virtual environment, such as a head-mounted VR device. The real scene image can be the scene image of the target virtual space that are visible to by the human eyes.

In an embodiment, the step S40 includes: obtaining the current pose for the target smart device; obtaining the real scene image in the target virtual space based on the current pose; correspondingly, after the determining the real scene image based on the current pose and the target virtual space, the method further includes: sending the real scene image to the target display device so that the target display device displays the real scene image.

It can be understood that after obtaining the current pose for the target smart device, using the current pose to obtain a real scene image in the target virtual space, and then projecting the real scene image to the target display device or sending the real scene image to the target display device in other ways for display. The target display device can be a display screen, an optical engine system, etc., to complete video perspective in the virtual scene.

In an embodiment, the obtaining the current pose for the target smart device includes: after triggering the tracking and positioning function to start, controlling the target smart device to perform SLAM processing; acquiring an image and motion data in a current scene during a tracking phase; and determining the current pose for the target smart device based on the image and motion data in the current scene.

It should be understood that triggering the tracking and positioning function to start in response to the second trigger command, and then controlling the target smart device to start normal SLAM processing. Calculating the current pose for the target smart device in the target virtual space using the image and motion data of the current scene during the tracking phase. The current pose can be represented by coordinates, for example, (x1, y1, z1).

This embodiment determines a video perspective descriptor based on the image for the first thread and a tracking and positioning descriptor based on the image for the second thread; matches the video perspective descriptor with the tracking and positioning descriptor; renders the current virtual space based on the descriptor matching result to obtain the target virtual space; and acquires the current pose for the target smart device and determines the real scene image based on the current pose and the target virtual space. By acquiring images from different threads in the above manner, determining the corresponding descriptors using their respective images, rendering the target virtual space using the descriptor matching result, and finally combining the current pose for the target smart device to determine the real scene image, thereby enabling high color rendering at low resolution and breaking through the resolution limitations of camera devices.

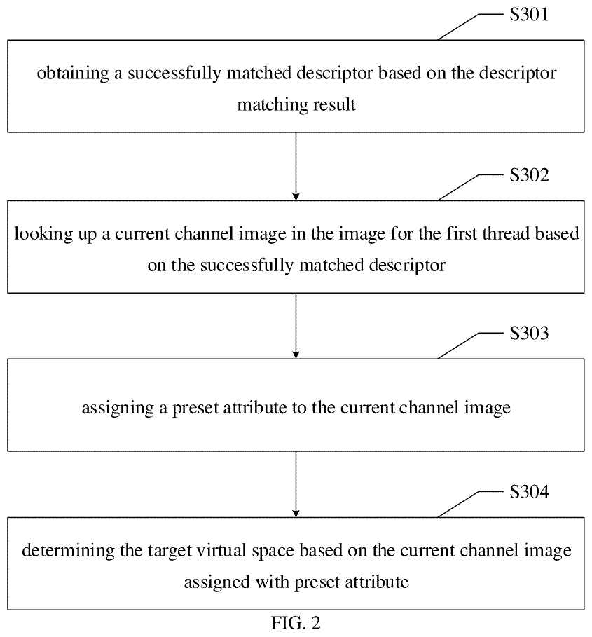

Based on the above embodiment of the present application, in another embodiment of the present application, the content that is the same as or similar to that in the above embodiment described above can refer to the above description and will not be repeated hereafter. Based on this, referring to FIG. 2, the step S30 also includes steps S301 to S304.

Step S301, obtaining a successfully matched descriptor based on the descriptor matching result.

It should be understood that a successfully matched descriptor refers to a descriptor that successfully matches the video perspective descriptor and the tracking and positioning descriptor. After obtaining the descriptor matching result, extracting a successfully matched descriptor from the descriptor matching result.

Step S302, looking up a current channel image in the image for the first thread based on the successfully matched descriptor.

It can be understood that the current channel images can be an RGB three-channel images. After obtaining a successfully matched descriptor, further obtaining the feature point corresponding to the successfully matched descriptor, and using the feature points to look up the current channel image in the image for the first thread.

Step S303, assigning a preset attribute to the current channel image.

It should be understood that the preset attribute refer to attribute added to the current channel image, and the preset attribute includes but not limited to feature point coordinates, descriptors, and colors.

Step S304, determining the target virtual space based on the current channel image assigned with preset attribute.

It can be understood that after assigning the attribute, rendering the target virtual space using the current channel image assigned with the preset attribute.

In an embodiment, the step S304 includes: constructing a current virtual space based on the current channel image assigned with preset attribute; projecting a feature point corresponding to the successfully matched descriptor onto the current virtual space; obtaining a target feature point adjacent to the feature point; and interpolating the current virtual space after projecting based on a color for the target feature point to obtain the target virtual space.

It should be understood that after obtaining the current channel image assigned with the preset attribute, constructing the current virtual space using the coordinate of the feature point assigned in the current channel image. Then, determining the feature point corresponding to the successfully matched descriptor, and projecting the feature point into the current virtual space using a preset projection method. The preset projection method can be a perspective projection method. The target feature point refers to the feature point adjacent to the feature point corresponding to the successfully matched descriptor. Then, extracting the color for the target feature point from the image for the first thread, and interpolating the color for the target feature point into the current virtual space to obtain the target virtual space. At this time, the image used to extract the color is the original image for the first thread, and the image used to convert the current black and white single-channel image is the image for the first thread after backing up.

This embodiment obtains a successfully matched descriptor based on a descriptor matching result; looks up the current channel image in the image for the first thread based on the successfully matched descriptor; assigns the preset attribute to the current channel image; and determines the target virtual space based on the current channel image assigned with preset attribute. Through using the above method, after obtaining the descriptor matching result, extracting the successfully matched descriptor from the descriptor matching result. Then, using the successfully matched descriptor to look up the current channel image in the image of the first thread. After successfully assigning the preset attribute, determining the target virtual space through color interpolation, thereby effectively improving the accuracy of determining the target virtual space.

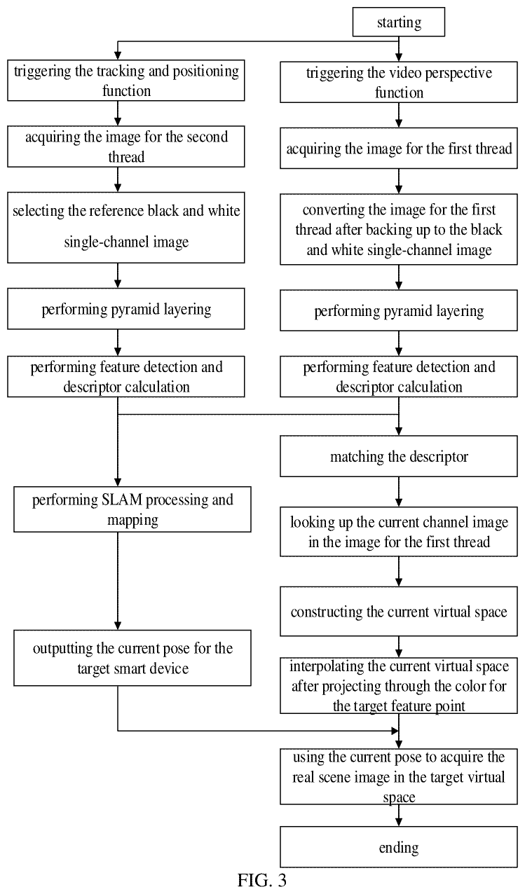

In an embodiment, in order to help understand the implementation flow of the method for controlling scene rendering obtained by combining this embodiment with the above embodiment. Referring to FIG. 3, FIG. 3 provides a simplified flow chart of the method for controlling scene rendering.

After triggering the video perspective function and tracking and positioning function to start respectively, the process splits into two branches. The first branch is configured to determine the tracking and positioning descriptor and the current pose of the target smart device. Specifically, after acquiring the image for the second thread using the target measurement unit and the second camera device, selecting a reference black and white single-channel image from the above image; performing pyramid layering on the reference black and white single-channel image; and performing feature detection and descriptor calculation using the ORB detection strategy to obtain the tracking and positioning descriptor. At this time, feeding back the tracking and positioning descriptor to the second branch; and performing SLAM processing in the first branch to determine the current pose for the target smart device. The second branch is configured to determine the video perspective descriptor and render the target virtual space. Specifically, after acquiring the image for the first thread using the first camera device, backing up the image. The image for the first thread after backing up is configured to determine the video perspective descriptor, and the original image for the first thread is configured to render the target virtual space. Specifically, converting the image for the first thread into a current black and white single-channel image, then performing pyramid layering on the current black and white single-channel image, and performing feature detection and descriptor calculation using an ORB detection strategy to obtain the video perspective descriptor. In addition, after receiving the tracking and positioning descriptor fed back from the first branch, matching the video perspective descriptor with the tracking and positioning descriptor; then, looking up the current channel image in the image for the first thread using the successfully matched descriptor, and constructing the current virtual space using the current channel image assigned with the preset attribute; interpolating the current virtual space after projecting based on the color for the target feature point to obtain the target virtual space; finally, using the current pose for the target smart device determined by the first branch to acquire the real scene image in the target virtual space to achieve high color rendering at low resolution and break through the limitations of the camera device resolution.

It should be noted that the above examples are only for understanding the present application and do not constitute a limitation on the method for controlling scene rendering of the present application. Any simple transformations based on this technical concept are within the protection scope of the present application.

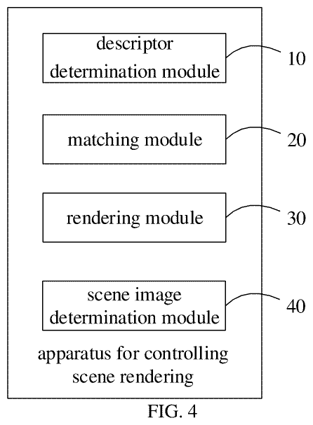

The present application also provides an apparatus for controlling scene rendering, as shown in FIG. 4, the apparatus for controlling scene rendering includes: a descriptor determination module 10, a matching module 20, a rendering module 30 and a scene image determination module 40.

The descriptor determination module 10 is configured to determine a video perspective descriptor based on an image for a first thread and determine a tracking and positioning descriptor based on an image for a second thread.

The matching module 20 is configured to match the video perspective descriptor with the tracking and positioning descriptor.

The rendering module 30 is configured to render a current virtual space based on a descriptor matching result to obtain a target virtual space.

The scene image determination module 40 is configured to acquire a current pose for a target smart device and determine a real scene image based on the current pose and the target virtual space.

This embodiment determines a video perspective descriptor based on the image for the first thread and a tracking and positioning descriptor based on the image for the second thread; matches the video perspective descriptor with the tracking and positioning descriptor; renders the current virtual space based on the descriptor matching result to obtain the target virtual space; and acquires the current pose for the target smart device and determines the real scene image based on the current pose and the target virtual space. By acquiring images from different threads in the above manner, determining the corresponding descriptors using their respective images, rendering the target virtual space using the descriptor matching result, and finally combining the current pose for the target smart device to determine the real scene image, thereby enabling high color rendering at low resolution and breaking through the resolution limitations of camera devices.

The apparatus for controlling scene rendering provided in the present application, employing the method for controlling scene rendering in the above embodiments, can solve the technical problem that the related art cannot achieve high color rendering at low resolution. Compared with the related art, the beneficial effects of the apparatus for controlling scene rendering provided in the present application are the same as those of the method for controlling scene rendering provided in the above embodiments, and other technical features in the apparatus for controlling scene rendering are the same as those disclosed in the methods of the above embodiments, and will not be repeated here.

In an embodiment, the descriptor determination module 10 is further configured to acquire an image for a first thread through a first camera device after triggering the video perspective function to start; convert the image for the first thread to obtain a current black and white single-channel image; perform pyramid layering on the current black and white single-channel image; perform feature detection on the current black and white single-channel image after performing pyramid layering to obtain a first feature point; acquire a first grayscale difference data based on the first feature point; and determine a video perspective descriptor based on the first grayscale difference data.

In an embodiment, the descriptor determination module 10 is further configured to, acquire an image for a second thread through a target measurement unit and a second camera device after triggering the start of the tracking and positioning function; select a reference black and white single-channel image from the image for the second thread; perform pyramid layering on the reference black and white single-channel image; perform feature detection on the reference black and white single-channel image after performing pyramid layering to obtain the second feature point; acquire a second grayscale difference data based on the second feature points and determine the tracking and positioning descriptor based on the second grayscale difference data.

In an embodiment, the rendering module 30 is further configured to obtain a successfully matched descriptor based on the descriptor matching result; look up the current channel image in the image for the first thread based on the successfully matched descriptor; assign a preset attribute to the current channel image; and determine the target virtual space based on the current channel image assigned with the preset attribute.

In an embodiment, the rendering module 30 is further configured to construct a current virtual space based on the current channel image assigned with the preset attribute; project the feature point corresponding to the successfully matched descriptor into the current virtual space; obtain a target feature point adjacent to the feature point; and interpolate the current virtual space after projecting based on the color for the target feature point to obtain the target virtual space.

In an embodiment, the scene image determination module 40 is further configured to obtain the current pose for the target smart device; obtain a real scene image in the target virtual space based on the current pose; and send the real scene image to the target display device so that the target display device displays the real scene image.

In one embodiment, the scene image determination module 40 is further configured to control the target smart device to perform SLAM processing after triggering the tracking and positioning function; acquire an image and motion data in the current scene during the tracking phase; and determine the current pose for the target smart device based on the image and motion data in the current scene.

The present application provides a device for controlling scene rendering, the device for controlling scene rendering includes: at least one processor and a memory communicatively connected to the at least one processor; the memory stores instructions executable by the at least one processor, and the instructions are executed by the at least one processor to enable the at least one processor to execute the method for controlling scene rendering in the above embodiment.

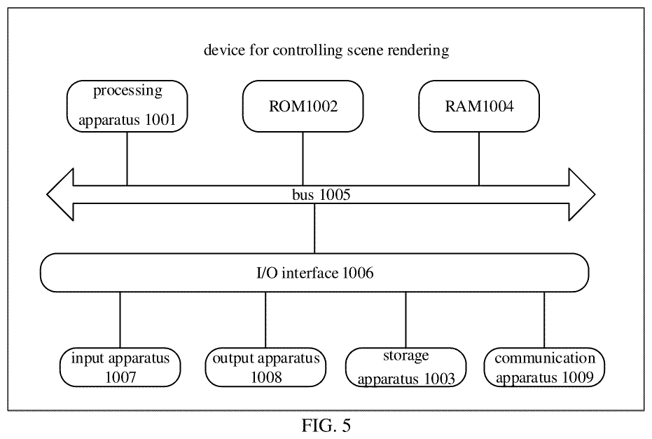

Referring to FIG. 5, FIG. 5 is a schematic diagram of a device structure of the hardware operating environment involved in the method for controlling scene rendering according to an embodiment of the present application. The device for controlling scene rendering in the embodiment of the present application may include, but is not limited to, mobile terminals such as mobile phones, laptops, digital broadcast receivers, Personal Digital Assistants (PDAs), Portable application Descriptions (PADs), Portable Media Players (PMPs), in-vehicle terminals (e.g., in-vehicle navigation terminals), and fixed terminals such as digital TVs and desktop computers. The device for controlling scene rendering shown in FIG. 5 is merely an example and should not impose any limitations on the functionality and scope of use of embodiments of the present application.

As shown in FIG. 5, the device for controlling scene rendering may include a processing apparatus 1001 (e.g., a central processing unit, a graphics processing unit, etc.), which can perform various appropriate actions and processes according to a program stored in a read-only memory (ROM) 1002 or a program loaded from a storage apparatus 1003 into a random access memory (RAM) 1004. The RAM 1004 also stores various programs and data required for the operation of the device for controlling scene rendering. The processing apparatus 1001, the ROM 1002, and the RAM 1004 are interconnected via a bus 1005. An input/output (I/O) interface 1006 is also connected to the bus. Typically, the following systems can be connected to the I/O interface 1006: an input apparatus 1007 including, for example, a touchscreen, a touchpad, a keyboard, a mouse, an image sensor, a microphone, an accelerometer, a gyroscope, etc.; an output apparatus 1008 including, for example, a liquid crystal display (LCD), a speaker, a vibrator, etc.; a storage apparatus 1003 including, for example, magnetic tape, hard disk, etc.; and a communication apparatus 1009. The communication apparatus 1009 allows the device for controlling scene rendering to communicate wirelessly or wiredly with other devices to exchange data. Although the drawing shows the device for controlling scene rendering with various systems, it should be understood that implementing or having all of the systems shown is not required. More or fewer systems may be implemented alternatively.

Specifically, according to the embodiments disclosed in the present application, the process described above with reference to the flow charts can be implemented as a computer software program. The computer program includes program code for performing the methods shown in the flow charts. In such embodiments, the computer program can be downloaded and mounted from a network via a communication apparatus, or mounted from storage apparatus 1003, or mounted from ROM 1002. When the computer program is executed by processing apparatus 1001, the functions described above as defined in the methods of the embodiments disclosed in the present application is executed.

The device for controlling scene rendering provided in the present application, employing the method for controlling scene rendering in the above embodiments, can solve the technical problem that the related art cannot achieve high color rendering at low resolution. Compared with the related art, the beneficial effects of the device for controlling scene rendering provided in the present application are the same as those of the method for controlling scene rendering provided in the above embodiments, and other technical features in this apparatus for controlling scene rendering are the same as those disclosed in the previous embodiment method, and will not be repeated here.

It should be understood that the various parts disclosed in the present application can be implemented using hardware, software, firmware, or a combination thereof. In the description of the above embodiments, specific features, structures, materials, or characteristics can be combined in any suitable manner in one or more embodiments or examples.

The above description is merely a specific embodiment of the present application, but the scope of protection of the present application is not limited thereto. Any variations or substitutions that can be easily conceived by those skilled in the art within the technical scope disclosed in the present application should be included within the scope of protection of the present application. Therefore, the scope of protection of the present application should be determined by the scope of the claims.

The present application provides a computer-readable storage medium having computer-readable program instructions (i.e., a computer program) stored on the computer-readable storage medium, and the computer-readable program instructions is configured to execute the method for controlling scene rendering in the above embodiments.

The computer-readable storage medium provided in the present application may be, for example, a USB flash drive, but is not limited to, electrical, magnetic, optical, electromagnetic, infrared, or semiconductor systems, devices, or any combination thereof. More specific examples of computer-readable storage media may include, but are not limited to: electrical connections with one or more wires, portable computer disks, hard disks, random access memory (RAM), read-only memory (ROM), erasable programmable read-only memory (EPROM or flash memory), optical fiber, portable compact disk read-only memory (CD-ROM), optical storage devices, magnetic storage devices, or any suitable combination thereof. In this embodiment, the computer-readable storage medium may be any tangible medium containing or storing a program that can be used by or in conjunction with an instruction execution system, system, or device. The program code contained on the computer-readable storage medium may be transmitted using any suitable medium, including but not limited to: wires, optical cables, RF (Radio Frequency), etc., or any suitable combination thereof.

The aforementioned computer-readable storage medium may be included in the device for controlling scene rendering; or may exist independently and not be assembled into the device for controlling scene rendering.

The computer program code for performing the operations of the present application can be written in one or more programming languages or a combination thereof, the programming language includes object-oriented programming languages such as Java, Smalltalk, and C++, and conventional procedural programming languages such as the “C” language or similar programming languages. The program code can be executed entirely on the computer of the user, partially on the computer of the user, as a standalone software package, partially on the computer of the user and partially on a remote computer, or entirely on a remote computer or a server. In cases involving remote computers, the remote computer can be connected to the computer of the user via any type of network, including a local area network (LAN) or a wide area network (WAN), or can be connected to an external computer (e.g., via the Internet using an Internet service provider).

The flow charts and block diagrams in the accompanying drawings illustrate the architecture, functionality, and operation that may be implemented according to various embodiments of the present application. In this regard, each block in a flow chart or block diagram may represent a module, segment, or portion of code containing one or more executable instructions for implementing the specified logical function. It should also be noted that in some alternative implementations, the functions marked in the blocks may occur in a different order than those shown in the drawings. For example, two consecutively indicated blocks may actually be executed substantially in parallel, and they may sometimes be executed in reverse order, depending on the functions involved. It should also be noted that each block in the block diagrams and/or the flow charts, and combinations of blocks in the block diagrams and/or the flow charts, can be implemented using a dedicated hardware-based system that performs the specified function or operation, or using a combination of dedicated hardware and computer instructions.

The modules described in the embodiments of the present application can be implemented in software or in hardware. The names of the modules do not constitute a limitation on the unit itself.

The readable storage medium provided in the present application is a computer-readable storage medium that stores computer-readable program instructions (i.e., a computer program) for executing the above method for controlling scene rendering, which can solve the technical problem that the related art cannot achieve high color rendering at low resolution. Compared with the related art, the beneficial effects of the computer-readable storage medium provided in the present application are the same as the beneficial effects of the method for controlling scene rendering provided in the above embodiments, and will not be repeated here.

The above description are some embodiments of the present application and do not limit the scope of the present application. Any equivalent structural modifications made using the contents of the specification and drawings of the present application under the technical concept of the present application, or any direct or indirect application in other related technical fields, are included within the scope of the present application.

What is claimed is:

1. A method for controlling scene rendering, comprising:
determining a video perspective descriptor based on an image for a first thread, and determining a tracking and positioning descriptor based on an image for a second thread;
matching the video perspective descriptor with the tracking and positioning descriptor;
rendering a current virtual space based on a descriptor matching result to obtain a target virtual space; and
obtaining a current pose for a target smart device, and determining a real scene image based on the current pose and the target virtual space.

2. The method according to claim 1, wherein the determining the video perspective descriptor based on the image for the first thread comprises:
after triggering video perspective function, acquiring the image for the first thread through a first camera device;
converting the image for the first thread to obtain a current black and white single-channel image;
performing pyramid layering on the current black and white single-channel image;
performing feature detection on the current black and white single-channel image after performing pyramid layering to obtain a first feature point; and
obtaining a first grayscale difference data based on the first feature point, and determining the video perspective descriptor based on the first grayscale difference data.

3. The method according to claim 1, wherein the determining the tracking and positioning descriptor based on the image for the second thread comprises:
after triggering the tracking and positioning function to start, acquiring the image for the second thread through a target measurement unit and a second camera device;
selecting a reference black and white single-channel image from the image for the second thread;
performing pyramid layering on the reference black and white single-channel image;
performing feature detection on the reference black and white single-channel image after performing pyramid layering to obtain a second feature point; and
obtaining a second grayscale difference data based on the second feature point, and determining the tracking and positioning descriptor based on the second grayscale difference data.

4. The method according to claim 1, wherein the rendering the current virtual space based on the descriptor matching result to obtain the target virtual space comprises:
obtaining a successfully matched descriptor based on the descriptor matching result;
looking up a current channel image in the image for the first thread based on the successfully matched descriptor;
assigning a preset attribute to the current channel image; and
determining the target virtual space based on the current channel image assigned with preset attribute.

5. The method according to claim 4, wherein the determining the target virtual space based on the current channel image assigned with preset attribute comprises:
constructing a current virtual space based on the current channel image assigned with preset attribute;
projecting a feature point corresponding to the successfully matched descriptor onto the current virtual space;
obtaining a target feature point adjacent to the feature point; and
interpolating the current virtual space after projecting based on a color for the target feature point to obtain the target virtual space.

6. The method according to claim 1, wherein the obtaining the current pose for the target smart device and determining the real scene image based on the current pose and the target virtual space comprises:
obtaining the current pose for the target smart device;
obtaining the real scene image in the target virtual space based on the current pose; and
correspondingly, after determining the real scene image based on the current pose and the target virtual space, the method further comprises:
sending the real scene image to the target display device so that the target display device displays the real scene image.

7. The method according to claim 1, wherein the obtaining the current pose for the target smart device comprises:
after triggering the tracking and positioning function to start, controlling the target smart device to perform simultaneous localization and mapping (SLAM) processing;
acquiring an image and motion data in a current scene during a tracking phase; and
determining the current pose for the target smart device based on the image and motion data in the current scene.

8. An apparatus for controlling scene rendering, comprising:
a descriptor determination module configured to determine a video perspective descriptor based on an image for a first thread and determine a tracking and positioning descriptor based on an image for a second thread;
a matching module configured to match the video perspective descriptor with the tracking and positioning descriptor;
a rendering module configured to render a current virtual space based on a descriptor matching result to obtain a target virtual space; and
a scene image determination module configured to acquire a current pose for a target smart device, and determine a real scene image based on the current pose and the target virtual space.

9. A device for controlling scene rendering, comprising: a memory, a processor, and a computer program stored in the memory and executable on the processor, wherein the computer program is configured to implement the method for controlling scene rendering according to claim 1.

10. A non-transitory storage medium, wherein the storage medium is a non-transitory computer-readable storage medium, a computer program is stored on the storage medium, and when the computer program is executed by a processor, the method for controlling scene rendering according to claim 1 is implemented.
